(19) United States
(12) Patent Application Publication
(10) Pub. No.: US 2008/0188975 A1
(43) Pub. Date: Aug. 7, 2008

(54) Control System for Monitoring Plastics Injection Molding Machines

(75) Inventor: Maurizio Bazzo, Oderzo (IT)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Inglass, S.p.A., San Polo Di Piave (IT)

(21) Appl. No.: 11/964,929

(22) Filed: Dec. 27, 2007

(30) Foreign Application Priority Data
Dec. 28, 2006 (IT) TV2006U 000059

(51) Int. Cl. G06F 17/00; B29C 45/03

(52) U.S. Cl. 700/110; 425/547

(57) ABSTRACT

A control system for monitoring plastics injection molding machines having a multiwire electric cable connecting the electronic central control unit of the machine to both the electric power unit of the machine and to the thermocouples arranged on the liquid-plastic injection device of the machine. The control system having a data processing unit, which is completely separate from and independent of the electronic central control unit of the machine, and processes the signals travelling along the multiwire electric cable of at least one plastics injection molding machine to determine any malfunctioning of the machine; and at least one data acquisition device connected to the multiwire electric cable to intercept the signals travelling along the multiwire electric cable, and to send copies of them directly to the data processing unit without interfering in any way with operation of the electronic central control unit of the machine.

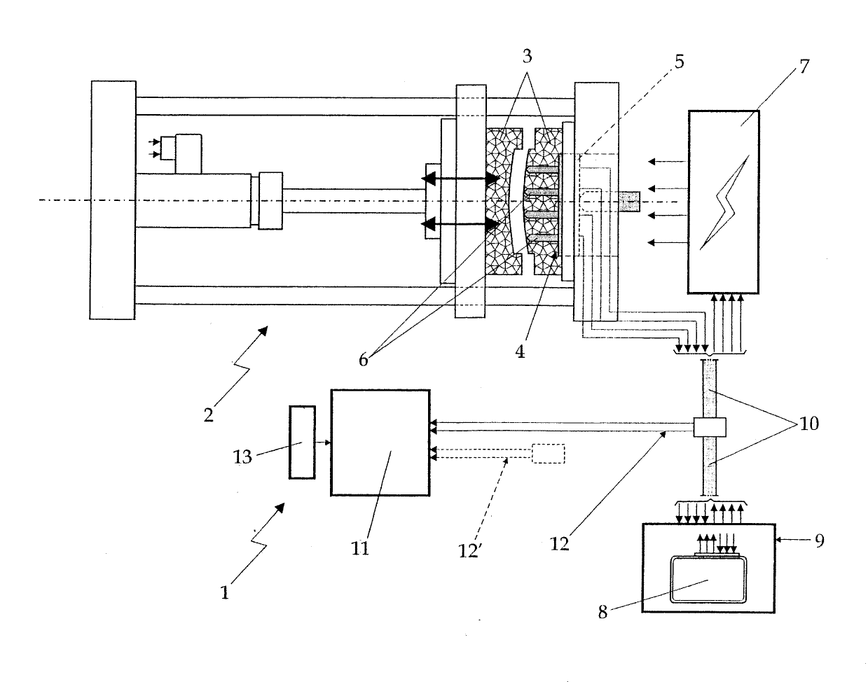

The present invention relates to a control system for monitoring plastics injection molding machines.

More specifically, the present invention relates to a control system for monitoring plastics injection molding machines, and to a plastics injection molding machine comprising such a system.

### BACKGROUND OF THE INVENTION

As is known, plastics injection molding machines comprise a mold, normally comprising at least two metal bodies, which are brought cyclically to rest one against the other, and form, at the contact surface between them, a closed, shaped cavity negatively reproducing the shape of the plastic part for molding; and a liquid-plastic injection or so-called “hot-channel” device for feeding the liquid plastic in controlled manner to the central mold cavity.

More specifically, the hot-channel device is housed in a seat formed on one of the two metal bodies of the mold, and substantially comprises a hollow metal body or so-called “hot chamber”, which is filled with liquid plastic; a number of injectors, which branch off from the “hot chamber” up to the central mold cavity, and regulate liquid-plastic outflow into the central mold cavity; and a number of electric heating units distributed along the body of the hot-channel device defined by the “hot chamber” and resistors, to Joule-effect heat the plastic material inside the hot-channel device.

Each heating unit in turn comprises at least one resistor appropriately located inside the body of the hot-channel device; and a corresponding thermocouple located close to the resistor to real-time measure the temperature of the portion of the hot-channel device around the resistor. Which temperature obviously depends directly on the amount of Joule heat produced by the resistor, and which is transmitted directly to the body of the hot-channel device and to the plastic material inside it.

The plastic material, in fact, must be kept liquid or semisolid at all times.

Known plastics injection molding machines also comprise an electric power unit which, on command, supplies electric energy independently to the individual resistors of the heating units; and an electronic central control unit connected to the thermocouples of the heating units, and which controls the electric power unit as a function of signals from the individual thermocouples, so that each resistor of the hot-channel device is powered electrically at all times to keep the temperature of the portion of the hot-channel device around the resistor at a specific reference value memorized in the central control unit.

For safety reasons, given the high electric power levels involved, the electric power unit of currently marketed plastics injection molding machines is completely separate from the electronic central control unit, and is located as close as possible to the hot-channel device, inside a protective casing.

Similarly, the electronic central control unit is housed inside its own protective casing, and is connected to the electric power unit and to the thermocouples of the heating units by a multiwire cable, normally several metres in length to locate the electronic central control unit at a safe distance from the machine.

In addition to first-assembly electronic central control units, which only provide for regulating electric power output of the heating unit resistors, much more sophisticated, high-cost electronic central control units are also marketed, and which incorporate a dedicated computer for continually monitoring the time pattern of the thermocouple temperature readings and of power output by the individual resistors, so as to determine, by means of special statistical-analysis algorithms, any malfunctioning of the hot-channel device and/or minor leakage of plastic material from the device, and so indicate the problem and shut down the machine immediately.

Unfortunately, electronic central control units with integrated computers have proved unsuccessful commercially, by being much more expensive than normal first-assembly units.

### SUMMARY OF THE INVENTION

It is an object of the present invention to provide a system designed to overcome, more cheaply, the limitations of normal first-assembly electronic central control units, which only provide for regulating electric power output of the heating unit resistors of the hot-channel device.

According to the present invention, there is provided a system for monitoring plastics injection molding machines, as claimed in the attached Claims.

According to the present invention, there is also provided a plastics injection molding machine, as claimed in the attached Claims.

### BRIEF DESCRIPTION OF THE DRAWING

The present invention will be described with reference to the attached drawing, which shows, schematically and with parts removed for clarity, a plastics injection molding machine featuring a control system for monitoring plastics injection molding machines in accordance with the teachings of the present invention.

### DETAILED DESCRIPTION OF THE INVENTION

Number 1 in the attached drawing indicates as a whole a control system specially designed for connection to a plastics injection molding machine 2, which, in the example shown, substantially comprises a mold 3 comprising at least two metal bodies, which are brought cyclically to rest one against the other, and form, at the contact surface between them, a closed, shaped cavity negatively reproducing the shape of the plastic part for molding; and a liquid-plastic injection device 4, or so-called “hot-channel device”, for feeding the liquid plastic in controlled manner to the central cavity of mold 3.

Mold 3 and plastic injection device 4 are both commonly known parts in the industry and therefore not described in detail, except to state that injection device 4 is housed inside a seat formed in one of the two metal bodies of mold 3, and substantially comprises a hollow metal body 5, or so-called “hot chamber”, which is filled with liquid plastic; one or more injectors 6, which branch off from hollow metal body 5 up to the central cavity of mold 3, and regulate liquid-plastic outflow into the cavity; and a number of electric heating units (not shown) distributed along the body of injection device 4 defined by hollow metal body 5 and resistors 6, to Joule-effect heat the plastic material inside injection device 4.

The heating units are also commonly known in the industry and therefore not described in detail, except to state that each comprises at least one resistor (not shown) located inside the body of injection device 4; and at least one thermocouple (not shown) or other temperature sensor, located close to the resistor to real-time measure the temperature of the portion of injection device 4 around the resistor.

Plastics injection molding machine 2 also comprises an electric power unit 7 which, on command, supplies electric energy independently to the individual resistors (not shown) of the heating units (not shown); and an electronic central control unit 8 connected to both electric power unit 7 and the thermocouples of the heating units, and which controls electric power unit 7 as a function of signals from the thermocouples.

More specifically, electronic central control unit 8 controls electric power unit 7 as a function of signals from individual thermocouples, so that each resistor of injection device 4 is powered electrically at all times to keep the temperature of the portion of injection device 4 around the resistor at a specific reference value memorized in electronic central control unit 8 and associated exclusively with that resistor, or rather with the portion of injection device 4 around the resistor.

For safety reasons, electronic central control unit 8 is an electric device completely separate from electric power unit 7, and is housed in a preferably, though not necessarily, metal protective casing 9; and plastics injection molding machine 2 has a multiwire electric cable 10 for connecting electronic central control unit 8 to both electric power unit 7 and the thermocouples of the heating units (not shown).

Control system 1 for monitoring plastics injection molding machines comprises a data processing unit 11 completely separate from and independent of electronic central control unit 8, and which, by means of special analysis algorithms, processes the signals travelling along multiwire electric cable 10 to determine any malfunctioning of machine 2, and so indicate the problem and/or shut down machine 2 immediately.

More specifically, data processing unit 11 is an electronic device completely separate from and independent of electronic central control unit 8, and control system 1 also comprises a data acquisition device 12 connected along, or to one end of, multiwire electric cable 10, to intercept the signals travelling along multiwire electric cable 10, and send copies of the signals directly to data processing unit 11 without interfering in any way with operation of electronic central control unit 8 of machine 2.

In the example shown, data processing unit 11 provides for reconstructing and processing, by means of special statistical-analysis algorithms, the time pattern of the temperature readings of the various thermocouples and/or the time pattern of power output by the individual resistors, so as to determine any minor leakage of plastic material from injection device 4, or any malfunctioning of injection device 4 and/or electric power unit 7 and/or any of the heating units, and then indicate the malfunction to the operator and/or automatically shut down machine 2 immediately.

In the example shown, data acquisition device 12 comprises a multiwire electric cable 12 branch-connected to multiwire electric cable 10 to intercept, and supply data processing unit 11 with copies of, all the electric signals travelling along multiwire electric cable 10. Data acquisition device 12 may obviously also be designed to transmit the signals, travelling along multiwire electric cable 10, directly by radio to data processing unit 11.

In the example shown in the attached drawing, data processing unit 11 comprises a control panel 13, by which to manually enter algorithm operating parameters by which to analyse the signals travelling along multiwire electric cable 10, or simply interrogate data processing unit 11 to display the time pattern of the temperature readings by the various thermocouples and/or of power output by individual resistors, or to acquire more information concerning the malfunction of injection device 4.

Operation of control system 1 for monitoring plastics injection molding machines, and of plastics injection molding machine 2, will be clear from the above description, with no further explanation required.

Control system 1 for monitoring plastics injection molding machines obviously has numerous advantages. In particular, it is extremely cheap to produce, by involving no direct dialog or interaction with any part of plastics injection molding machine 2, and so enabling the use of conventional, low-cost, readily available electronic components of proven reliability.

Also, being totally passive, control system 1 involves no reconfiguration and/or part replacements of machine 2.

Clearly, changes may be made to control system 1, for monitoring plastics injection molding machines, as described herein, without, however, departing from the scope of the present invention.

For example, data processing unit 11 of control system 1 may simultaneously process signals travelling along a number of multiwire electric cables 10 forming part of different plastics injection molding machines 2, so as to parallel monitor operation of a number of plastics injection molding machines 2. In which case, control system 1 will obviously comprise a number of data acquisition devices 12, 12′, each connected to the multiwire electric cable 10 of a respective machine 2 for monitoring.

The possibility of simultaneously monitoring a number of plastics injection molding machines 2 obviously provides for considerable scale economy, by dividing the purchase cost of control system 1 between a number of machines 2, thus making control system 1 much more attractive than currently used electronic central control units with built-in computers.

1) A control system (1) for monitoring plastics injection molding machines (2) comprising a plastic material injection device (4) having a number of electric heating units appropriately arranged in the body of the injection device (4); each heating unit comprising at least one resistor located in the body of said injection device (4), and at least one temperature sensor located close to said resistor to measure the temperature of the portion of the injection device (4) around the resistor; said plastics injection molding machines (2) also comprising an electric power unit (7) which, on command, supplies electric energy independently to the individual resistors of the heating units, and an electronic central control unit (8) connected to the temperature sensors of said heating units, and which controls said electric power unit (7) as a function of signals from said temperature sensors; said electric power unit (7) and said electronic central control unit (8) being two distinct, separate electric devices; and said plastics injection molding machines (2) also comprising a multiwire electric cable (10) connecting the electronic central control unit (8) to both said electric power unit (7) and the temperature sensors of said heating units;
said control system (1) being characterized by comprising a data processing unit (11), which is completely separate from and independent of said electronic central control unit (8), and processes the signals travelling along the multiwire electric cable (10) of at least one said plastics injection molding machine (2) to determine any malfunctioning of the machine (2); and at least one data acquisition device (12, 12′) connected to said multiwire electric cable (10) to intercept the signals travelling along said multiwire electric cable (10), and to send copies of them directly to the data processing unit (11) without interfering in any way with operation of said electronic central control unit (8).

2) A control system as claimed in claim 1, characterized in that said data processing unit (11) reconstructs and then processes, by means of statistical-analysis algorithms, the time pattern of the temperature readings of the temperature sensors of said heating units, and/or the time pattern of the power output of the resistors of said heating units, to determine any malfunctioning of the machine (2).

3) A control system as claimed in claim 1, characterized in that said data acquisition device (12, 12′) comprises a second multiwire electric cable (12, 12′) designed for branch connection to the multiwire electric cable (10) of said plastics injection molding machine (2); said second multiwire electric cable (12, 12′) being designed to intercept, and supply said data processing unit (11) with copies of, all the electric signals travelling along the multiwire electric cable (10) of said plastics injection molding machine (2).

4) A control system as claimed in claim 1, characterized in that said data acquisition device (12, 12′) is designed to transmit the signals, travelling along the multiwire electric cable (10) of said plastics injection molding machine (2), directly by radio to said data processing unit (11).

5) A plastics injection molding machine (2), characterized by comprising a control system (1) as claimed in claim 1.
